(19) United States
(12) Patent Application Publication
(10) Pub. No.: US 2011/0210850 A1
(43) Pub. Date: Sep. 1, 2011

(54) TOUCH-SCREEN KEYBOARD WITH COMBINATION KEYS AND DIRECTIONAL SWIPES

(76) Inventor: Phuong K Tran, Milpitas, CA (US)

(21) Appl. No.: 12/713,175

(22) Filed: Feb. 26, 2010

(51) Int. Cl. G08B 21/00; G06F 3/041

(52) U.S. Cl. 340/540; 345/173

(57) ABSTRACT

A touch-screen keyboard for small mobile devices that improves typing accuracy and speed by using directional swipes to select letters or symbols in combination keys containing multiple letters or symbols per key.

### CROSS-REFERENCE TO RELATED APPLICATIONS

Not Applicable

### FIELD OF THE INVENTION

The present invention relates to text data entry for small electronic mobile devices such as cellular phones and touch screen pads.

### BACKGROUND OF THE INVENTION

Modern mobile devices, such as cellular phones, typically have features such as email and text messages that require users to enter text. Because of the small sizes of mobile devices, text entry is usually a challenging task when using these devices. Some devices combine multiple letters or digits in each physical key, and user have to press a key one or multiple times to select the desired letter or digit. Other devices such as Apple's iPhone use a touch-screen keyboard. These keyboards usually have tiny keys, making text entry difficult, slow and error prone.

### BRIEF SUMMARY OF THE INVENTION

In one aspect, systems and methods are disclosed to enter data on a touch screen keyboard by displaying one or more combination keys, each representing a plurality of letters or symbols; and swiping a finger across the touch screen to enter data.

Implementations of the above aspect may include one or more of the following. Each combination key contains multiple, preferably four, letters or symbols. The user can perform a short swipe on the keyboard touch-screen instead of a touch to select a desired letter, digit or symbol. The system utilizes multiple characteristics of a swipe including its position (start, end or middle point of the swipe path) and direction (angle) to determine the letter, digit or symbol that user intends to type. The system can select a combination key based on a position of a swipe and a letter or symbol in the combination key based on swipe direction. The system can operate in an inward swipe mode in which swiping in the direction from a predetermined letter or symbol in a combination key toward the center of the combination key selects the predetermined letter or symbol. Alternatively, the system can operate in an outward swipe mode in which swiping in the direction from the center of a combination key toward a predetermined letter or symbol in the combination key selects the predetermined letter or symbol.

Advantages of the preferred embodiments may include one or more of the following. The touch-screen keyboard works with small mobile devices and can help users to type faster and more accurately. The use of combination keys reduces the number of keys on the keyboard, thus allows larger keys on the limited size of a touch-screen and helps users to make fewer typing errors. Directional swipe gesture is more intuitive than the multiple-click method used by regular phone and can help users to type faster.

### BRIEF DESCRIPTION OF THE DRAWING

FIG. 1 shows an exemplary view of a touch-screen keyboard with combination keys according to one embodiment of the present invention.

FIG. 2 shows an exemplary view of directional swipes to select certain letters in the keyboard.

FIG. 3 is a flow chart illustrating the operation of one embodiment of a touch-screen keyboard with combination keys.

FIG. 4 shows an exemplary portable electronic mobile device.

### DETAILED DESCRIPTION OF THE INVENTION

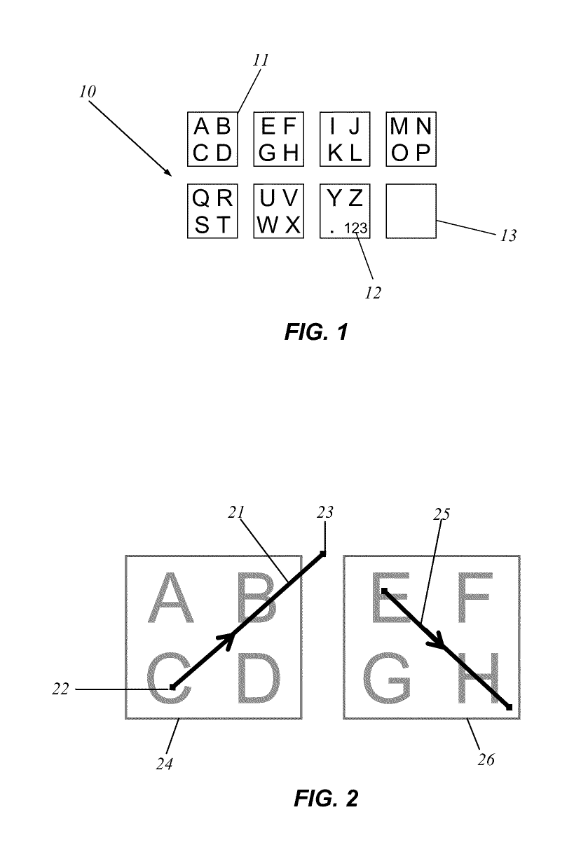

Referring now to the invention in more detail, FIG. 1 shows a touch-screen keyboard 10 in which combination key 11 contains four letters. Some key may contain a special symbol. For example, special symbol 12 is used to toggle the input mode from alphabet to numeric. A key 13 may contain a single symbol such as space.

When typing, user does a short swipe on a combination key in the touch-screen surface to select a letter or symbol among multiple letters of symbols in that combination key. There are two modes of operations: inward swipe and outward swipe. In inward swipe mode, to type a letter or symbol, user swipes in the direction from the position of that letter or symbol in the key toward the center of the key. In outward swipe mode, to select a letter or symbol, user swipe in the direction from the center of the key toward that letter or symbol. FIG. 2 illustrates two swipes in outward swipe mode. Swipe 21 in the direction from the center of key 24 toward the letter B near the top-left corner of that key (i.e. approximately 45-degree angle) will select letter B. Similarly, swipe 25 selects letter H from key 26. The selected letter or symbol will be briefly highlighted or magnified to provide a visual confirmation to the user. If a key contains a single symbol, user can just touch the key to select that symbol. Selection of the inward or outward mode is a user preference and can be set in the device setup or configuration menu.

Generally, each swipe will be characterized by its point position (location) and its direction (angle). Both the point position and the direction of the swipe are used to determine the letter or symbol typed. The point position of the swipe can be defined to be the starting point 22 of the swipe path, the ending point 23 of the path, or some point in between. The definition of the point position of the swipe can be a user preference and can be configured in the device setup menu. A sliding bar can be used to help the user to configure the definition of the point position of the swipe relative to the swipe path, with the left end of the bar corresponding to the starting point of the swipe, and the right end the ending point. For example, if the slider is set at 50 percent (in the middle) of the bar, then the mid-point of the swipe path will be used to represent the point position of the swipe.

The point position of the swipe is used to determine which combination key in the keyboard is selected. The key containing the point position of the swipe, or the key closest to the point position of the swipe, if no key contains the point position of the swipe, will be the selected key.

Once the combination key is selected using the point position of the swipe, the direction (angle) of the swipe is used to select a letter or symbol among the letters of symbols in the selected combination key. The conventional 360 degree circle is divided into multiple angle ranges. Each letter of symbol in the combination key is associated with an angle range according to the position of that letter or symbol relative to the center of the key. A letter or symbol is selected if the direction of the swipe falls within the angle range associated with that letter or symbol.

For example, if the key contain 4 letters A, B, D, and C arranged in clock-wise order starting with letter A in the top-left corner as showed in key 24 in FIG. 2, then in outward swipe mode, a swipe in a direction (angle) between 0 degree to 90 degree, like the 45-degree swipe 21 in FIG. 2, will select letter B. A swipe with a direction (angle) between 90 degree to 180 degree will select letter A, and so on. Similarly, in inward swipe mode, a swipe in a direction (angle) between 180 degree to 270 degree will select letter B, and a swipe in a direction (angle) between 270 degree to 360 degree will select letter A, for example.

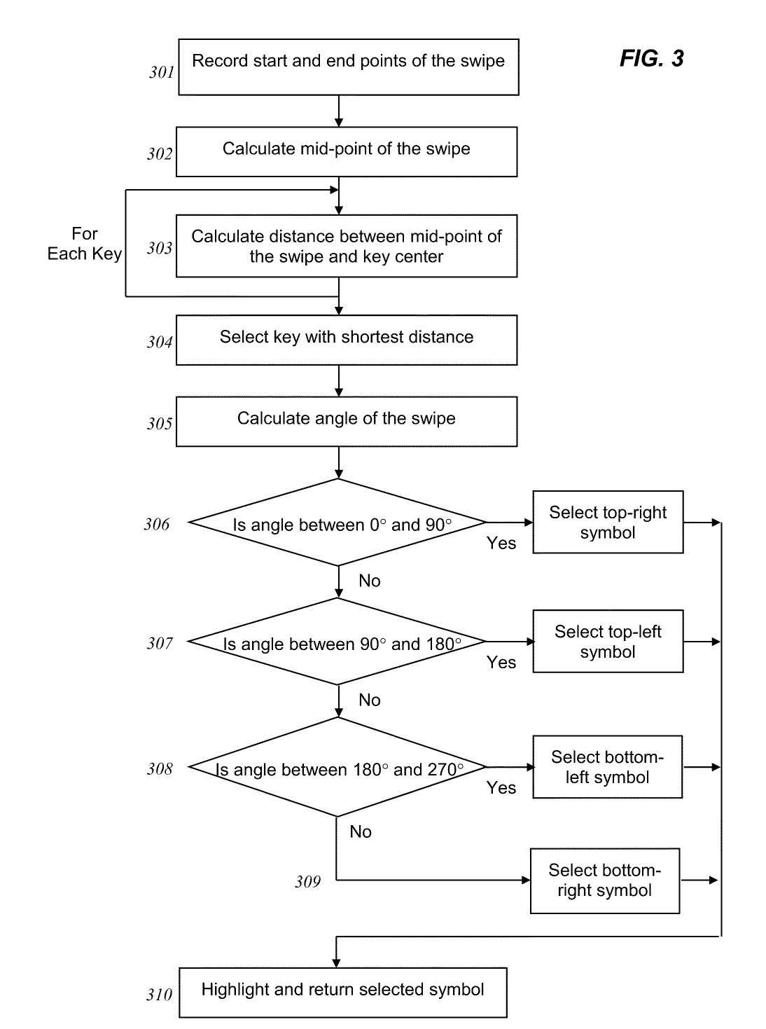

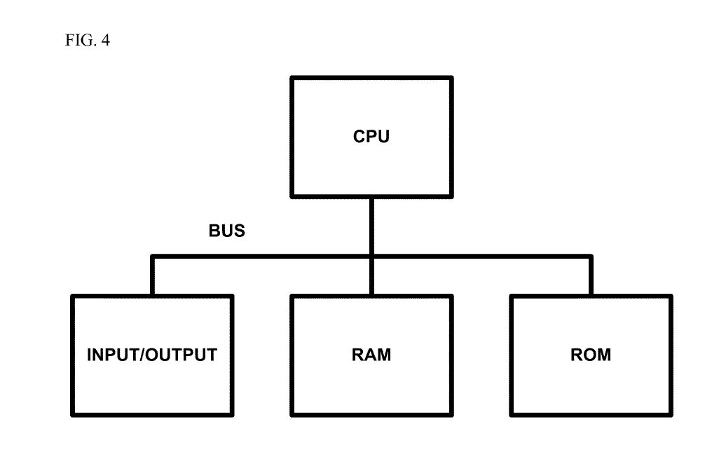

The flow chart in FIG. 3 illustrates the operations of an embodiment of the keyboard in the outward swipe mode described above. In this embodiment, each combination key contains four letters or symbols, and the point position of a swipe is configured to be the midpoint of the swipe path. The algorithm to detect a letter/symbol entered by a user is described in the steps below.
1. In step 301, the device detects a swipe of the user's finger on the touch-screen surface and records the coordinate of the start point of the swipe path on the tough screen surface as (x1, y1) and the end point of the swipe path as (x2, y2).
2. In step 302, the mid-point (x, y) of the swipe is calculated, where x=(x1+x2)/2 and y=(y1+y2)/2. This mid-point (x, y) will be referred as the swipe position.
3. In step 303, the distance between the swipe position (x, y) and the center of each combination key in the keyboard is calculated.
4. Step 304 selects the combination key whose center has the shortest distance to the swipe position (x, y).
5. Step 305 calculates the angle A (direction) of the swipe: A=arctangent((y2−y1)/(x2−x1)). Angle A can be used to select one of the four letters/symbols in the combination key selected in step 304 above.
6. If angle A is around 45 degree (between 0 and 90 degree), step 306 selects the top-right letter/symbol of the selected combination key.
7. If angle A is around 135 degree (between 90 and 180 degree), step 307 selects the top-left letter/symbol of the selected combination key.
8. If angle A is around 225 degree (between 180 and 270 degree), step 308 selects the bottom-left letter/symbol of the selected combination key.
9. Otherwise if angle A is around 315 degree (between 270 and 360 degree), step 309 selects the bottom-right letter/symbol of the selected combination key
10. Finally, in step 310, the selected letter/symbol is briefly highlighted or magnified to provide a visual confirmation to the user. The selected letter/symbol is then returned/sent to the application that requires the keyboard input.

In another embodiment, the keyboard can have one, two, three, four, or more letters/symbols per key. For example, if a key contains two letters placed horizontally, swiping left to right will select the right letter, and right to left will select the left letter. On the keyboard, the letters, symbols and combination keys can be arranged alphabetically or similarly to QWERTY keyboard or in any other arrangement.

In addition to linear swipes as described above, user can also use non-linear swipes such as circular or multi-segment swipes to type certain symbols. Non-linear swipes can be position-insensitive, i.e. only the directions and/or the shape of the swipe, not the point position of the swipe, is used to select the symbol. For example, user can swipe in 270-degree direction (top down) followed by a 180-degree direction (right to left) anywhere on the keyboard touch-screen surface to type the “Enter” symbol. In another example, user can swipe in 180-degree direction (right to left) then reverses (left to right) to type a “Back space”, or she can swipe in 90-degree direction (bottom up) the reverses (top down) to “Shift”.

Occasionally there may be some ambiguity in the user's swipe gesture. For example, the swipe direction can be at (or near) the border of two angle ranges corresponding to two adjacent letters in the combination key. In this case, linguistic and/or statistical methods such as a dictionary, letter frequency or conditional probability can be used to pick the letter/symbol the user most likely intends to type, or simply no letter/symbol will be selected and an error indication such as a vibration or visual shaking of the key will be given to the user.

The advantages of the present invention may include, without limitation, the use of combination keys which reduces the number of keys on the keyboard, increases the key size, and thus reduces typographical errors. The directional swipe method is more intuitive and faster than the multiple-click or multiple-touch methods used in other types of keyboards with combination keys.

In addition to the system of FIG. 3, statistical recognizers can be used for recognizing the data input. Bayesian networks provide not only a graphical, easily interpretable alternative language for expressing background knowledge, but they also provide an inference mechanism; that is, the probability of arbitrary events can be calculated from the model. Intuitively, given a Bayesian network, the task of mining interesting unexpected patterns can be rephrased as discovering item sets in the data which are much more—or much less—frequent than the background knowledge suggests. These cases are provided to a learning and inference subsystem, which constructs a Bayesian network that is tailored for a target prediction. The Bayesian network is used to build a cumulative distribution over events of interest.

In another embodiment, a genetic algorithm (GA) search technique can be used to find approximate solutions to identifying the user's data entry. Genetic algorithms are a particular class of evolutionary algorithms that use techniques inspired by evolutionary biology such as inheritance, mutation, natural selection, and recombination (or crossover). Genetic algorithms are typically implemented as a computer simulation in which a population of abstract representations (called chromosomes) of candidate solutions (called individuals) to an optimization problem evolves toward better solutions. Traditionally, solutions are represented in binary as strings of 0s and 1s, but different encodings are also possible. The evolution starts from a population of completely random individuals and happens in generations. In each generation, the fitness of the whole population is evaluated, multiple individuals are stochastically selected from the current population (based on their fitness), modified (mutated or recombined) to form a new population, which becomes current in the next iteration of the algorithm.

Substantially any type of learning system or process may be employed to determine the user's swipe motions so that unusual events can be flagged.

In one embodiment, clustering operations are performed to detect patterns in the data. In another embodiment, a neural network is used to recognize each pattern as the neural network is quite robust at recognizing user habits or patterns. Once the treatment features have been characterized, the neural network then compares the input user information with stored templates of treatment vocabulary known by the neural network recognizer, among others. The recognition models can include a Hidden Markov Model (HMM), a dynamic programming model, a neural network, a fuzzy logic, or a template matcher, among others. These models may be used singly or in combination.

Dynamic programming considers all possible points within the permitted domain for each value of i. Because the best path from the current point to the next point is independent of what happens beyond that point. Thus, the total cost of [i(k), j(k)] is the cost of the point itself plus the cost of the minimum path to it. Preferably, the values of the predecessors can be kept in an M×N array, and the accumulated cost kept in a 2×N array to contain the accumulated costs of the immediately preceding column and the current column. However, this method requires significant computing resources. For the recognizer to find the optimal time alignment between a sequence of frames and a sequence of node models, it must compare most frames against a plurality of node models. One method of reducing the amount of computation required for dynamic programming is to use pruning. Pruning terminates the dynamic programming of a given portion of user habit information against a given treatment model if the partial probability score for that comparison drops below a given threshold. This greatly reduces computation.

Considered to be a generalization of dynamic programming, a hidden Markov model is used in the preferred embodiment to evaluate the probability of occurrence of a sequence of observations O(1), O(2), . . . O(t), . . . , O(T), where each observation O(t) may be either a discrete symbol under the VQ approach or a continuous vector. The sequence of observations may be modeled as a probabilistic function of an underlying Markov chain having state transitions that are not directly observable. In one embodiment, the Markov network is used to model a number of user habits and activities. The transitions between states are represented by a transition matrix A=[a(i,j)]. Each a(i,j) term of the transition matrix is the probability of making a transition to state j given that the model is in state i. The output symbol probability of the model is represented by a set of functions B=[b(j) (O(t)], where the b(j) (O(t) term of the output symbol matrix is the probability of outputting observation O(t), given that the model is in state j. The first state is always constrained to be the initial state for the first time frame of the utterance, as only a prescribed set of left to right state transitions are possible. A predetermined final state is defined from which transitions to other states cannot occur. Transitions are restricted to reentry of a state or entry to one of the next two states. Such transitions are defined in the model as transition probabilities. In each state of the model, the current feature frame may be identified with one of a set of predefined output symbols or may be labeled probabilistically. In this case, the output symbol probability b(j) O(t) corresponds to the probability assigned by the model that the feature frame symbol is O(t). The model arrangement is a matrix A=[a(i,j)] of transition probabilities and a technique of computing B=b(j) O(t), the feature frame symbol probability in state j. The Markov model is formed for a reference pattern from a plurality of sequences of training patterns and the output symbol probabilities are multivariate Gaussian function probability densities. The patient habit information is processed by a feature extractor. During learning, the resulting feature vector series is processed by a parameter estimator, whose output is provided to the hidden Markov model. The hidden Markov model is used to derive a set of reference pattern templates, each template representative of an identified pattern in a vocabulary set of reference treatment patterns. The Markov model reference templates are next utilized to classify a sequence of observations into one of the reference patterns based on the probability of generating the observations from each Markov model reference pattern template. During recognition, the unknown pattern can then be identified as the reference pattern with the highest probability in the likelihood calculator. The HMM template has a number of states, each having a discrete value. However, because treatment pattern features may have a dynamic pattern in contrast to a single value. The addition of a neural network at the front end of the HMM in an embodiment provides the capability of representing states with dynamic values. The input layer of the neural network comprises input neurons. The outputs of the input layer are distributed to all neurons in the middle layer. Similarly, the outputs of the middle layer are distributed to all output states, which normally would be the output layer of the neuron. However, each output has transition probabilities to itself or to the next outputs, thus forming a modified HMM. Each state of the thus formed HMM is capable of responding to a particular dynamic signal, resulting in a more robust HMM. Alternatively, the neural network can be used alone without resorting to the transition probabilities of the HMM architecture.

The system may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, FIG. 4 shows a block diagram of a computer to support the system. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

In one embodiment, the device can be a phone such as the iPhone. The iPhone has a 3G cellular transceiver devices, ROM and RAM. For display, the iPhone has a 3.5 inches (8.9 cm) liquid crystal display (320×480 pixels) HVGA, acting as a touch screen that has been created for the use with one finger or multiple fingers. No stylus is needed nor can it be used, since the touch screen is not compatible with it. For the text input, the data entry system shown in FIGS. 1-3 can be used. The data entry system can work with the iPhone's built-in spell-checker, predictive word capabilities and a dynamic dictionary that retains new words. The predictive words capabilities have been integrated with the data entry system described above so that the user does not have to be perfectly accurate when typing—unwitting swipe on the edges of the nearby letters on the keyboard will be corrected when possible.

In another embodiment, the device can be a music player such as the iPod. All iPods (except the current iPod Shuffle and iPod Touch) have five buttons and the later generations have the buttons integrated into the click wheel—an innovation that gives an uncluttered, minimalist interface. The buttons perform basic functions such as menu, play, pause, next track, and previous track. Other operations, such as scrolling through menu items and controlling the volume, are performed by using the click wheel in a rotational manner. The current iPod Shuffle does not have any controls on the actual player; instead it has a small control on the earphone cable, with volume-up and -down buttons and a single button for play/pause, next track, etc. The iPod Touch has no click-wheel; instead it uses a 3.5″ touch screen in addition to a home button, sleep/wake button and (on the second and third generations of the iPod touch) volume-up and -down buttons. The user interface for the iPod touch is almost identical to that of the iPhone. Differences include a slightly different Icon theme and lack of the Phone application on the iPod touch. Both devices use the iPhone OS.

In yet another embodiment, the device can be a tablet computer such as the iPad. The footprint of the iPad is roughly the same as that of a netbook though the iPad is wider because its display uses the “conventional” 4:3 aspect ratio. However, since the iPad is a tablet and not a clamshell, it is thinner than any netbook, and lighter, too. While most netbooks are in the 2.5 pound range, the iPad weighs 1.5 pounds and is a scaled-up version of the iPhone. As a result, the iPad does not need very powerful (and power-hungry) hardware to do what it does quickly and effortlessly.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method to enter data on a touch screen, comprising:
displaying one or more combination keys, each representing a plurality of letters or symbols; and
swiping a finger across the touch screen to enter data.

2. The method of claim 1, wherein each combination key contains four letters or symbols.

3. The method of claim 1, comprising performing a short swipe on the keyboard touch-screen instead of a touch to select a desired letter, digit or symbol.

4. The method of claim 1, comprising:
characterizing a swipe with multiple variables including length, position including start, end or middle point of the swipe path and direction or angle of the swipe; and
using a combination of multiple variables to select a letter, digit or symbol.

5. The method of claim 1, comprising selecting a combination key based on a position of a swipe.

6. The method of claim 5, comprising:
using a start point or an end point of a swipe path as the position of the swipe or
using a predetermined point between the start point and the end point of the swipe path as the position of the swipe.

7. The method of claim 5, comprising selecting the combination key with the shortest distance to the position of the swipe.

8. The method of claim 1, comprising determining a letter or a symbol based on a swipe direction or angle.

9. The method of claim 8, comprising operating in an inward swipe mode in which swiping in the direction from a predetermined letter or symbol in a combination key toward the center of the combination key selects the predetermined letter or symbol.

10. The method of claim 8, comprising operating in an outward swipe mode in which swiping in the direction from the center of a combination key toward a predetermined letter or symbol in the combination key selects the predetermined letter or symbol.

11. The method of claim 8, comprising:
dividing the 360 degree circle into a plural of angle ranges;
associating each letter or symbol in a combination key with an angle range according to a relative position of the letter or symbol in the key; and
selecting the letter or symbol if the swipe angle is within the angle range associated with the letter or symbol.

12. The method of claim 1, comprising performing non-linear swipes to enter data.

13. The method of claim 1, comprising performing a circular swipes or multi-segment swipes to enter data.

14. The method of claim 1, comprising:
applying linguistic, conditional probability, or statistical model to select a character when there is ambiguity; and
providing a warning indication if ambiguity exists in determining a character.

15. The method of claim 1, comprising:
capturing a start point of a swipe path as (x1, y1) and an end point of a swipe path as (x2, y2);
determining a swipe position as a mid-point (x, y) of a swipe, where x=(x1+x2)/2 and y=(y1+y2)/2;
determining a distance between the swipe position (x, y) and a center of each combination key in a keyboard;
selecting a combination key whose center has the shortest distance to the swipe position (x, y);
determining an angle A (direction) of the swipe as A=arctangent((y2−y1)/(x2−x1)); and
using the angle A to select one of the letters, numbers or symbols in the combination key.

16. The method of claim 1, comprising:
selecting a top-right letter, number or symbol of the combination key if the swipe angle A is around 45 degree;
selecting a top-left letter, number or symbol of the combination key if the swipe angle A is around 135 degree;
selecting a bottom-left letter, number or symbol of the combination key if the swipe angle A is around 225 degree; and
selecting a bottom-right letter, number or symbol of the combination key if the swipe angle A is around 315 degree.

17. The method of claim 1, comprising:
selecting a bottom-left letter, number or symbol of the combination key if the swipe angle A is around 45 degree;
selecting a bottom-right letter, number or symbol of the combination key if the swipe angle A is around 135 degree;
selecting a top-right letter, number or symbol of the combination key if the swipe angle A is around 225 degree; and
selecting a top-left letter, number or symbol of the combination key if the swipe angle A is around 315 degree.

18. The method of claim 1, comprising briefly highlighting or magnifying a selected letter, number or symbol to provide a visual confirmation to the user.

19. A portable electronic device, comprising:
a touch screen;
a processor coupled to the touch screen;
code executable by the processor to display a combination of keys representing a plurality of letters or symbols and code to detect a finger swipe across the touch screen to enter data.

20. The device of claim 19, wherein each combination key contains four letters or symbols.

21. The device of claim 19, wherein a user performs a short swipe on the touch-screen instead of a touch to select a desired letter, digit or symbol.

22. The device of claim 19, comprising:
code executable by the processor to characterize a swipe with multiple variables including length, position including start, end or mid point of a swipe and direction or angle of the swipe; and
code executable by the processor to use a combination of multiple variables to select a letter, digit or symbol.

23. The device of claim 19, comprising code executable by the processor to select a combination key based on a position of the swipe.

24. The device of claim 19, comprising code executable by the processor to select a letter or symbol in a combination key based on a swipe direction.

25. The device of claim 19, comprising code executable by the processor to vibrate or give an indicator to warn of ambiguity in character determination.
